(19) United States
(12) Patent Application Publication
(10) Pub. No.: US 2019/0184776 A1
(43) Pub. Date: Jun. 20, 2019

(54) PUMP ASSEMBLY

(71) Applicant: The Goodyear Tire & Rubber Company, Akron, OH (US)

(72) Inventor: Cheng-Hsiung LIN, Hudson, OH (US)

(21) Appl. No.: 15/845,208

(22) Filed: Dec. 18, 2017

(51) Int. Cl. B60C 23/12; F04B 45/04; F04B 45/047; F04B 53/10

(52) U.S. Cl. CPC B60C 23/12; F04B 53/10; F04B 45/047; F04B 45/041

(57) ABSTRACT

A double acting pump mechanism is described for mounting on a wheel for inflating a pneumatic tire. The double acting pump mechanism includes a housing having a first pump chamber and a second pump chamber; wherein a diaphragm separates the first pump chamber from the second pump chamber; the housing further including an inlet port in fluid communication with the first pump chamber, and an outlet port in fluid communication with the second pump chamber, and wherein the outlet of the first pump chamber is in fluid communication with the inlet of the second pump chamber; a striker plate is positioned for reciprocation in the housing; the striker plate being connected to a diaphragm holder, wherein the diaphragm holder engages the diaphragm and actuates the diaphragm in the first and second pump chamber. Preferably the striker plate is actuated by a permanent or electro magnet mounted on a stationary part, or the striker plate is actuated by an electrically driven magnet.

### FIELD OF THE INVENTION

The present invention relates to a pump system and method for maintaining appropriate air pressure within a pneumatic tire. More specifically, the present invention relates to a wheel mounted system for directing air into a tire cavity of a pneumatic tire.

### BACKGROUND OF THE INVENTION

Conventional pneumatic tires are designed to perform for relatively long periods of time. In many cases, automobile tires are now expected to have a useful service life of 30,000, 50,000, or 70,000 miles. However, even long-life pneumatic tires are subject to air pressure losses due to puncture by nails and other sharp objects, temperature changes, and/or diffusion of air through the tire itself.

Since air diffusion reduces tire pressure over time, the pneumatic tires are often continually underinflated. Accordingly, drivers must repeatedly act to maintain tire pressures or fuel economy, tire life, and/or vehicle braking and handling performance will be reduced. Tire Pressure Monitoring Systems (TPMS) have been proposed to warn drivers when tire pressure is significantly low. Such systems, however, remain dependent upon a driver taking remedial action, when warned, to re-inflate a tire to the recommended pressure. It is desirable, therefore, to incorporate an air maintenance feature within a pneumatic tire that will maintain recommended air pressure without requiring bothersome driver intervention.

While pumping systems have been proposed, many are often too mechanically complex and costly. Consumers are not willing to pay for an expensive pump system. Thus, an improved simple, low cost pump that is easy to install is desired. The pump system must have a low-profile design so that is does not interfere with the mounting of the tire or other mechanical components.

### SUMMARY OF THE INVENTION

A pumping mechanism in accordance with the present invention is used with a pneumatic tire mounted on a wheel to keep the pneumatic tire from becoming underinflated. According to a first aspect of the invention, a double acting pump mechanism is described for mounting on a wheel for inflating a pneumatic tire. The double acting pump mechanism includes a housing having a first pump chamber and a second pump chamber; wherein a diaphragm separates the first pump chamber from the second pump chamber; said housing further including an inlet port in fluid communication with the first pump chamber, and an outlet port in fluid communication with the second pump chamber, and wherein the outlet of the first pump chamber is in fluid communication with the inlet of the second pump chamber; a striker plate is positioned for reciprocation in the housing; said striker plate being connected to a diaphragm holder, wherein said diaphragm holder engages the diaphragm and actuates the diaphragm in the first and second pump chamber. Preferably the striker plate is actuated by a permanent or electro magnet mounted on a stationary part, or the striker plate is actuated by an electrically driven magnet.

### DETAILED DESCRIPTION OF DRAWINGS

The following drawings are illustrative of examples of the present invention.

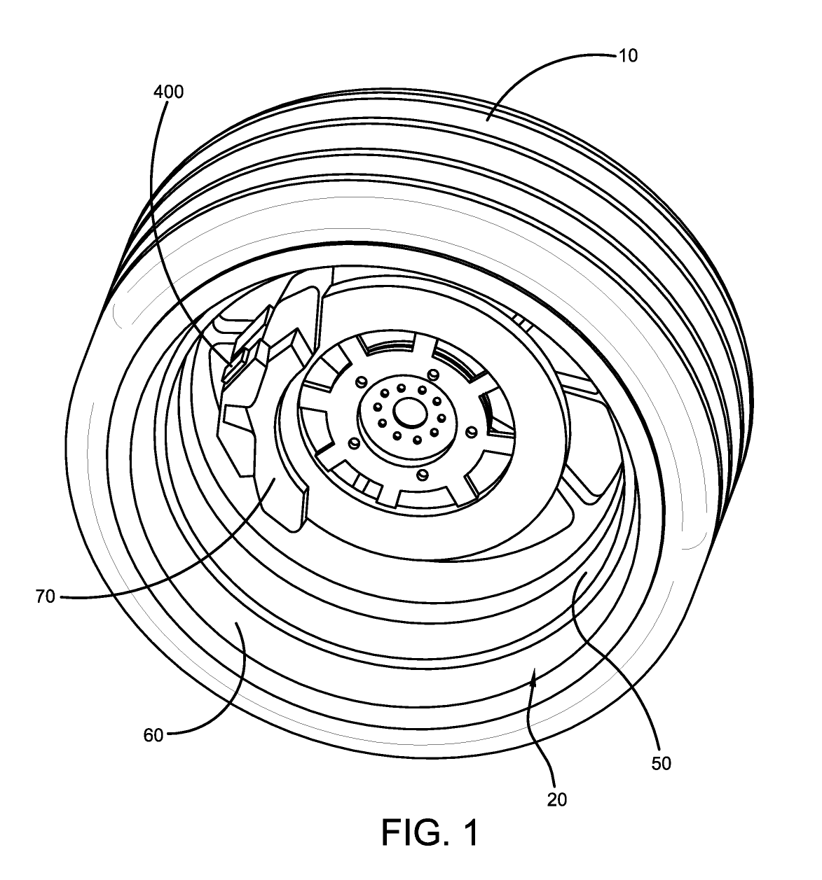

FIG. 1 is a perspective view of a wheel and pump system of the present invention.

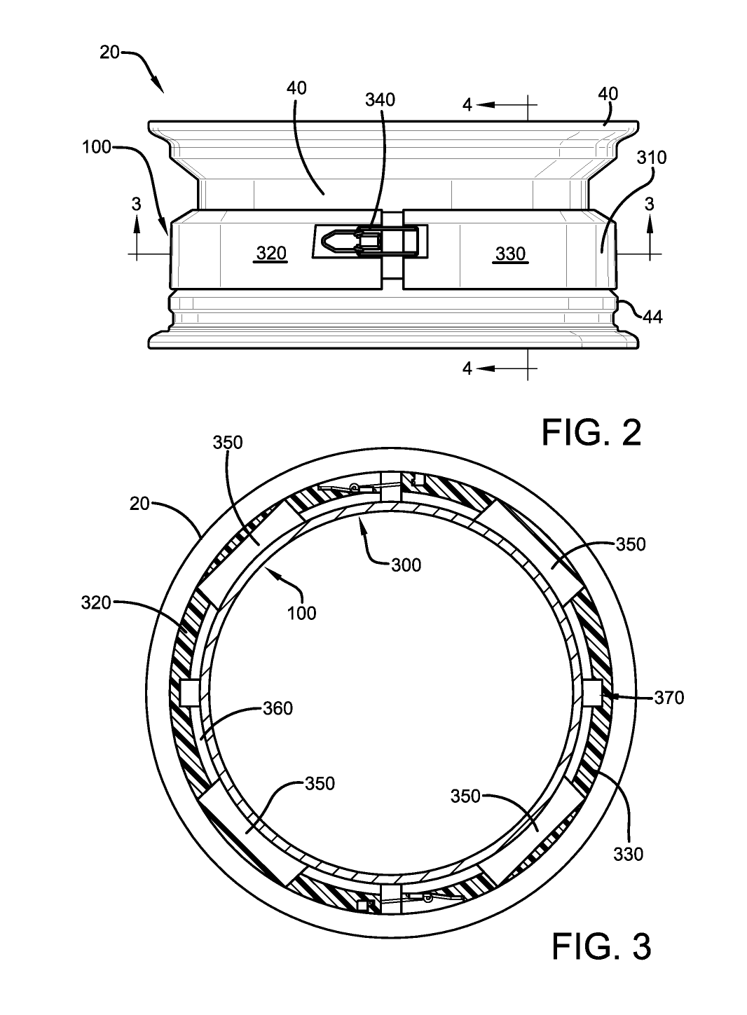

FIG. 2 is a side view of the wheel of FIG. 1 shown with the tire removed;

FIG. 3 is a cross-sectional view of the pump system in the direction 3-3 of FIG. 2;

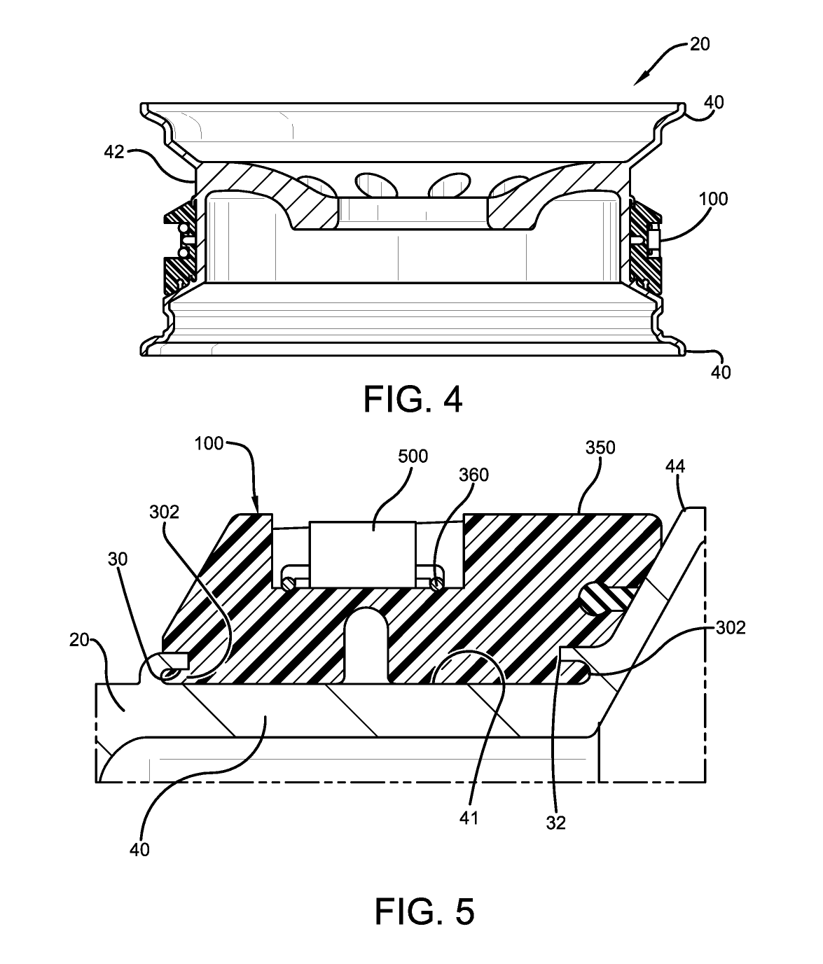

FIG. 4 is a cross-sectional view of the pump system in the direction 4-4 of FIG. 2.

FIG. 5 is a close-up view of the pump system of FIG. 4;

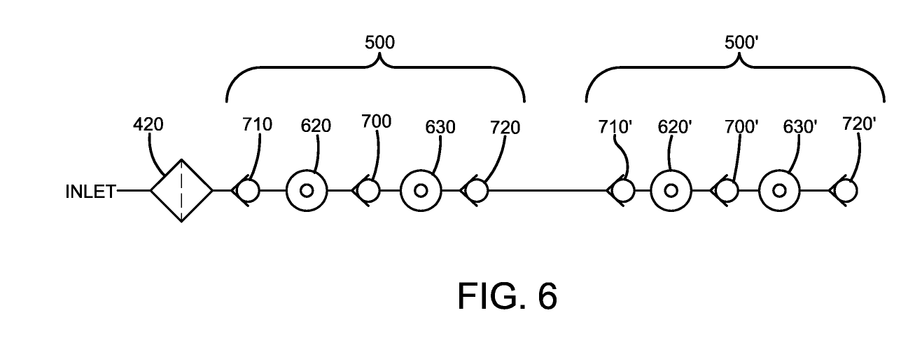

FIG. 6 is a schematic view of the pump system with the pumps connected in series;

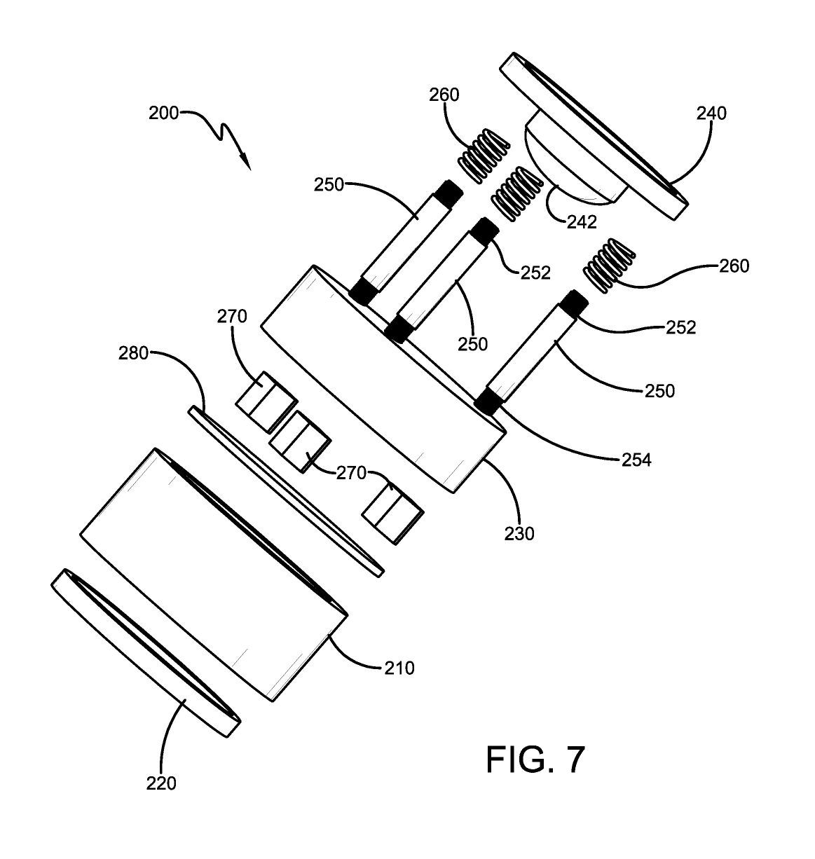

FIG. 7 is an exploded view of a double action pump of the present invention;

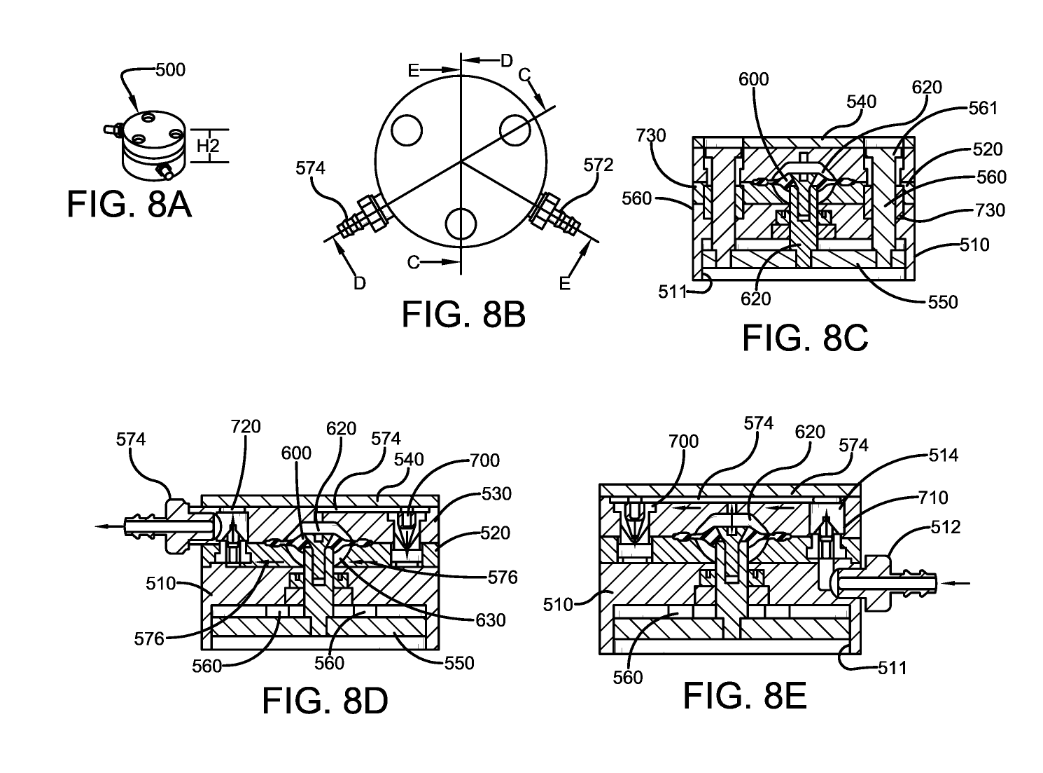

FIG. 8A is a perspective view of the double acting pump;

FIG. 8B is a top view of the double acting pump;

FIG. 8C is a cross-sectional view in the direction D-D of FIG. 8B;

FIG. 8D is a cross-sectional view in the direction C-C of FIG. 8B;

FIG. 8E is a cross-sectional view in the direction B-B of FIG. 8B;

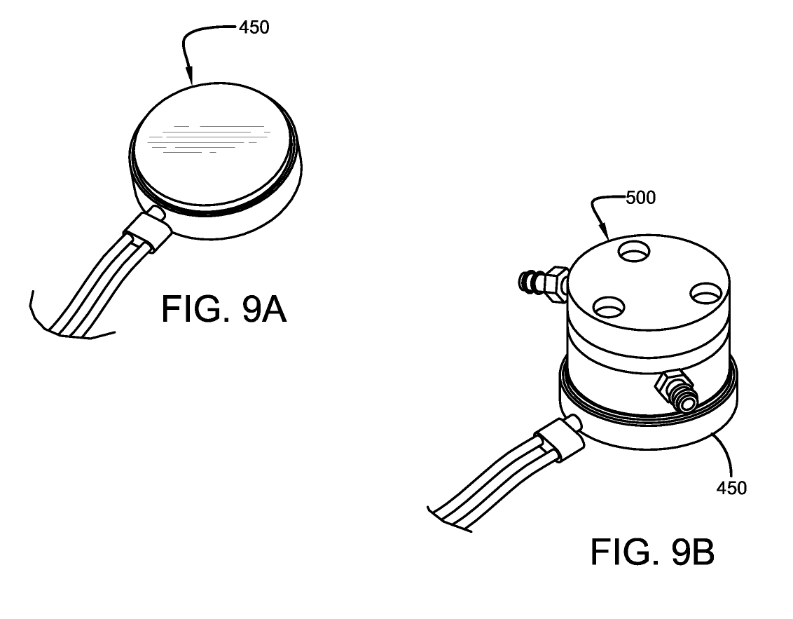

FIG. 9A is a perspective view of an electro magnet suitable for use with the present invention, while FIG. 9B illustrates the electromagnet assembled to the pump.

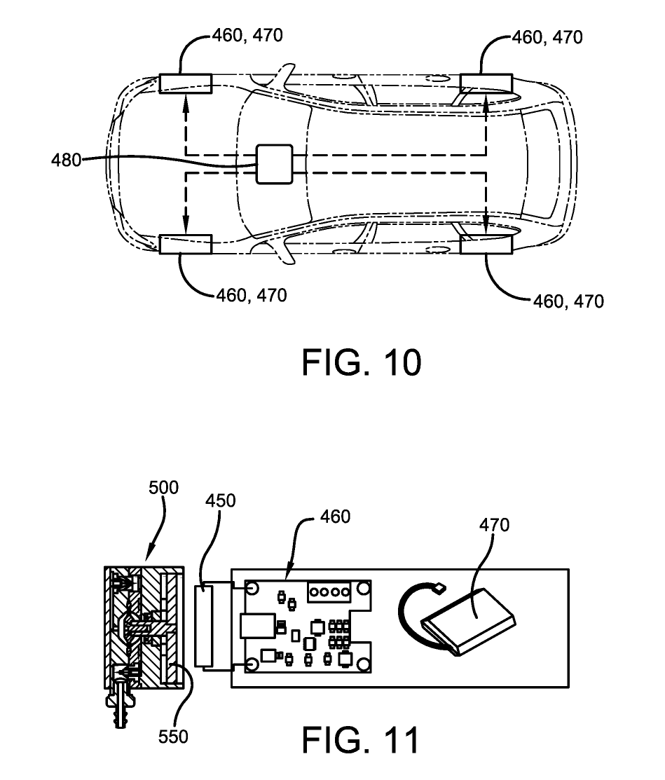

FIG. 10 is a schematic of an exemplary vehicle with tires having the pump of the present invention, and the location of the power receivers on the vehicle;

FIG. 11 is a schematic of the pump, micro-control system and power management system.

### DETAILED DESCRIPTION OF EXAMPLES OF THE PRESENT INVENTION

FIGS. 1 through 5 illustrate a wheel 20 which houses a low-profile pump system 100 of the present invention. A conventional tire 10 is mounted on the wheel and encloses the pump system in the tire cavity. As shown in FIG. 2, the wheel 20 may be conventional. As shown in FIG. 5, the wheel 20 is preferably modified to include opposed grooves 30 located on the rim flange 40. The groove is preferably U shaped or any desired shape that could easily mount a pump system therein. The low-profile pump system 100 is preferably received in the groove 30. The pump system housing is designed to have a snap in fit in the groove 30. A snap in insert 50 conceals the pump system on the outer wheel surface 60. Preferably, the low-profile pump system 100 includes one or more low profile pumps 500. Each low-profile pump 500 is mounted in a housing 300. The outer surface 310 of the pump housing is preferably flush with the rim flange 40. The low-profile pump 500 is designed to have a minimal height H in the radial direction when the pump is mounted on the rim flange. The radial height of the pump system is preferably minimized to less than or equal to the Tire and Rim Assembly or ETRTO defined standard tire rim well depth.

A low-profile pump preferable for use with the invention is a double acting diaphragm pump 500 as shown in FIGS. 7 through 9. The pump is preferably low profile having a minimized height H2 in the radial direction. The pump 500 has an inlet port 512 and an outlet port 514 as shown in FIG. 8B. An exploded view is shown in FIG. 7. The pump has a lower frame 510 that includes an inner chamber 511 for reciprocation of a strike plate 550 as shown in FIG. 8E. The strike plate 550 is housed in the inner chamber 511 and is connected to reciprocating guide rods 560 that slide in bearing sleeves 730. A resilient spring 565 is positioned between the upper end 561 of the guide rod and the upper support frame 520 for biasing the strike plate radially outward of the diaphragm 600. The diaphragm pump 500 has two chambers, a first or radially outer chamber 620 and a second or radially inner chamber 630. The two chambers are preferably in fluid communication with each other, so that the outlet air from the first chamber is fed into the inlet of the second chamber. The diaphragm 600 is affixed to a holder 620 by screw 610 and is positioned for reciprocation in each chamber 620,630. The holder 620 is affixed to the strike plate 550, so that the diaphragm reciprocates in the chambers 620,630 by actuation of the strike plate 550. A gasket 820 and bearing collar 800 is received about the support holder 620.

The pathway of the air is shown in FIGS. 8D and 8E. Air enters the pump via inlet 512 and is fed into a first passageway 514 thru a one-way check valve 710. The first passageway is in fluid communication with the radially outer or first chamber 620. The compressed air exits through a second check valve 700 and then into lower passageway 516 that feeds the second chamber 630. The lower passageway 516 is formed between the middle housing 520 and lower housing 510. The compressed air then exits the check valve 720 into valve outlet 514.

The driving force of the pump 500 may be a permanent magnet 400 that is placed on a fixed or stationary position near the wheel (i.e., does not rotate with the wheel), such as the brake system or suspension system as shown in FIG. 1. As shown in FIGS. 2-3, the pump housing is snap fit into opposed grooves 30 of a rim flange, so that the strike plate 550 is in electrical communication with the permanent magnet 400. Preferably, the strike plate faces the permanent magnet 400. Multiple permanent magnets 400 may be used at spaced apart intervals.

The driving force of the pump may also be from an electrically energized magnet or electromagnet 450 capable of being switched on and off as shown in FIG. 9a. If an electric magnet 450 is used, then the pumping action is controlled by the energized action (on/off) of the electric magnet. The electric magnet 450 is preferably positioned adjacent the strike plate as shown in FIG. 9B. The electromagnet has the advantage of providing fluid control of the system since it may be switched on and off. FIG. 11 illustrates the pump 500 and electromagnet 450, and how the electrical connection of each electromagnet 450 is achieved. Each electromagnet 450 on a given wheel is connected to a microcontroller 460, wherein each microcontroller 460 has a built-in charging receiver and may include an optional Tire Pressure Monitoring System or TPMS unit. Each microcontroller 460 is mounted on the rim, inside the tire. The TPMS unit is configured from several components including pressure, temperature sensors to measure and communicate the tire pressure and tire temperature data. Each microcontroller receives power from a power receiver 470, which is also mounted on the rim inside the tire. The power receiver 470 includes a wireless charging receiver, a rechargeable battery or a supercapacitor. Each power receiver 470 is in electrical communication with a wireless power charging transmitter 480, that is preferably mounted on a vehicle.

FIG. 6 illustrates the pump system 100 with two or more double acting diaphragm pumps 500, 500′ wherein the pump chambers 620,630 are arranged in series, so that the outlet of a first pump chamber 620 is fed into the inlet of the second pump chamber 630. Multiple pumps may additionally be used, and also connected in series. Preferably, a check valve 410 is located between each of the pump chamber connections to prevent backflow. Due to an amplification effect of connecting the pump passageways in series, the compression of the pump driving mechanism may be defined as:

R=(r)²ⁿ
where
R: system compression ratio
r: single chamber compression ratio
n: number of pump in the system
   Thus, a high compression ratio for each pump 500 is not necessary to achieve an overall high compression ratio of the pump system (e.g., low force and/or deformation may produce high compression). The pump system may also optionally include a filter 420. The air inlet to the pump system maybe from a passageway in the valve stem, as describe in patent application No. 62/398,981 filed on Sep. 23, 2016 and application No. 15/707,052 filed on Sep. 18, 2017 (both of which are incorporated by reference in their entirety), or from a passageway in the rim. Air enters the tire cavity from the outlet of the last pump.

In an alternate embodiment, any of the one or more pumps may be arranged in a groove on the wheel outside of the tire.

In an alternate embodiment, the driving force may be from the rotational energy of the wheel imparting energy to the strike plate or plunger plate. The mass of the strike plate or plunder sized to actuate as the wheel rotates. No magnet is needed.

The low-profile pump system as described herein have the advantage of a simple, low cost system that is easy to install on a wheel, and solves the problem of low tire pressure. The system is light, durable and provides a high driving force. The system may be used on consumer and commercial truck systems.

While certain representative examples and details have been shown for the purpose of illustrating the present invention, it will be apparent to those skilled in this art that various changes and modifications may be made therein without departing from the spirit or scope of the present invention.

What is claimed:

1. A pump mechanism for mounting on a wheel for inflating a pneumatic tire, the pump mechanism comprising:
a housing having a first pump chamber and a second pump chamber; wherein a diaphragm separates the first pump chamber from the second pump chamber; said housing further including an inlet port in fluid communication with the first pump chamber, and an outlet port in fluid communication with the second pump chamber, and wherein the outlet of the first pump chamber is in fluid communication with the inlet of the second pump chamber; and
a strike plate positioned for reciprocation in the housing; said strike plate being connected to a diaphragm holder, wherein said diaphragm holder engages the diaphragm and actuates the diaphragm in the first and second pump chamber.

2. The pump mechanism of claim 1 wherein the striker plate is actuated by a permanent magnet.

3. The pump mechanism of claim 1 wherein the striker plate is actuated by a electromagnet.

4. The pump mechanism of claim 1 wherein the first pump chamber is formed from a curved surface of the interior surface of the frame.

5. The pump mechanism of claim 1 wherein the striker plate is connected to a reciprocating guide rail.

6. The pump mechanism of claim 5 wherein a spring is positioned between a first end of the reciprocating guide rail and the housing for biasing the striker plate in a direction away from the housing.

7. The pump mechanism of claim 1 wherein the pump mechanism has a height less than 20 mm.

8. The pump mechanism of claim 1 wherein the pump mechanism is mounted inside the wheel rim on the rim flange.

9. The pump mechanism of claim 1 wherein the pump utilizes gravitational force changes during rotation of the pneumatic tire as a driving force.

10. The pump mechanism as set forth in claim 1 wherein the striker plate is actuated by a permanent magnet.

11. The pump mechanism of claim 10 wherein the permanent magnet is mounted on a brake caliper.

12. The pump mechanism as set forth in claim 1 wherein the load on the pneumatic tire does not affect frequency of pumping action of the pumping mechanism.

13. The pump mechanism of claim 1 wherein the strike plate is actuated by an electromagnet.

14. The pump mechanism as set forth in claim 1 further comprising a second pump, wherein the outlet of the first pump is connected in series to the inlet of the second pump.

15. The pump mechanism of claim 14 wherein a check valve is positioned between the first pump and the second pump.

16. The pump mechanism as set forth in claim 1 wherein the pump is mounted into a housing that is snap fits into a groove of the rim.

17. The pump mechanism as set forth in claim 1 wherein a check valve is positioned between the pump inlet and the first pump cavity.

18. The pump mechanism as set forth in claim 1 wherein a check valve is positioned between the first pump cavity and the second pump cavity.

19. The pump mechanism as set forth in claim 1 wherein a check valve is positioned between the first pump cavity and the second pump cavity.

20. The pump mechanism as set forth in claim 1 wherein a check valve is positioned between the second pump cavity and the pump outlet.

21. The pump mechanism as set forth in claim 1 further including a control valve unit.

22. The pump mechanism as set forth in claim 1 wherein a control valve is disposed at an air inlet to the pump.

23. The pneumatic tire as set forth in claim 1 wherein a control valve is disposed at an air outlet of the pump.

24. The pump mechanism as set forth in claim 1 wherein the pump mechanism is configured to have a bypass control mode to recirculate the flow from the last pump in the series to an upstream point.
